(19) United States
(12) Patent Application Publication
(10) Pub. No.: US 2010/0278088 A1
(43) Pub. Date: Nov. 4, 2010

(54) METHOD AND SYSTEM FOR USING POWER MANAGEMENT BITS IN ACKNOWLEDGMENT (ACK) FRAMES RECEIVED FROM WIRELESS ACCESS POINTS

(76) Inventor: Gregory Goldman, Danville, CA (US)

Correspondence Address: MCANDREWS HELD & MALLOY, LTD, 500 WEST MADISON STREET, SUITE 3400, CHICAGO, IL, 60661, US

(21) Appl. No.: 12/434,401

(22) Filed: May 1, 2009

(51) Int. Cl. G08C 17/00

(52) U.S. Cl. 370/311

(57) ABSTRACT

Aspects of a method and system for using power management bits in acknowledgment (ACK) frames received from wireless access points (AP). A STA may exit the power save (PS) mode and transmit a trigger frame to the AP. The trigger frame may comprise an identifier that identifies the STA. The trigger frame may comprise a request that the recipient AP determine whether there is buffered data pending delivery to the STA identified in the trigger frame. In response to the received trigger frame, the AP may transmit to the STA an ACK frame which comprises power management information, the value of which may indicate to the STA that the AP has no data to transmit to the STA. Upon receipt of the ACK frame, the STA may return to the PS mode based on the indication value in the power management information.

### CROSS-REFERENCE TO RELATED APPLICATIONS/INCORPORATION BY REFERENCE

NOT APPLICABLE

### FIELD OF THE INVENTION

Certain embodiments of the invention relate to communication networks. More specifically, certain embodiments of the invention relate to a method and system for using power management bits in acknowledgment (ACK) frames received from wireless access points (AP).

### BACKGROUND OF THE INVENTION

Networked devices may be connected to other networked devices via a network, such as a local area network (LAN), a metropolitan area network (MAN), or wide area network (WAN) such as the Internet. Networks may utilize wired networking technologies and/or wireless networking technologies. IEEE 802 describes communication architectures, which enable networked devices to communicate via a LAN or MAN.

A given networked device may utilize procedures to reduce power consumption. When reducing power consumption the host may enter an inactive state while still enabling the networked device to be accessible to other networked devices on the network.

IEEE 802.11 describes a communication architecture, which may enable networked devices to communicate via wireless local area networks (WLANs). One of the building blocks for the WLAN is the basic service set (BSS). A BSS may comprise a plurality of networked devices, or stations (STA), which may communicate wirelessly via one or more RF channels within a coverage area. The span of a coverage area may be determined based on the distance over which a source STA may transmit data via an RF channel, which may be received by a destination STA.

Within a BSS, a STA may operate in two power management modes: an active mode (AM) and/or a power-save mode (PS). When the STA is operating in the AM, the STA may be fully powered (within the capabilities of the power supply, for example) and may transmit and/or receive data. When the STA is operating in the PS mode (or “sleeping”), the STA may enter a doze state during which it operates at lower power consumption (when compared to AM) and capabilities for receiving data may be disabled.

When a STA within a BSS is operating in an AM, the AP may send data to the STA. When the STA is operating in PS mode, the AP may store, or buffer, data, which is to be sent to the STA. In a STA, which utilizes unscheduled automatic power save delivery (U-APSD), the STA may periodically exit the PS mode and, for example, return to AM operation (or “wake up”). After exiting the PS mode, the STA may send a trigger frame to the AP. The trigger frame may inform the AP that the STA has exited PS mode. The AP may send an acknowledgment (ACK) frame to the STA in response to the received trigger frame. The AP may subsequently determine whether there is buffered data that is awaiting transmission to the STA. In instances when there is no data awaiting transmission to the STA, the AP may send a null (QoS-Null) frame to the STA. The QoS-Null frame may comprise an end of service period (EOSP) indication. The value of the EOSP indication, for example EOSP=1, may indicate to the STA that the AP has no data to transmit to the STA. Upon receipt of the QoS-Null frame with EOSP=1 indication from the AP, the STA may send an ACK frame to the AP. The STA may subsequently return to the PS mode.

In instances when there is data awaiting transmission to the STA, the AP may send a data (Data) frame to the STA. When the data frame comprises all of the data awaiting transmission to the STA, the Data frame may comprise an EOSP indication, for example EOSP=1, to indicate to the STA that the AP has no further data to transmit to the STA. Upon receipt of the Data frame with EOSP=1 indication from the AP, the STA may send an ACK frame to the AP. The STA may subsequently return to the PS mode.

The time duration that begins when the STA transmits a trigger frame to the AP and ends when the STA transmits an ACK frame in response to a received frame from the AP comprising an EOSP=1 indication, is referred to as a turnaround time.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for using power management bits in acknowledgment (ACK) frames received from wireless access points (AP), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for wireless data communication, which may be utilized in connection with an embodiment of the invention.

FIG. 2 is a block diagram of an exemplary networked device, which may be utilized in connection with an embodiment of the invention.

FIG. 3 is a diagram that illustrates an exemplary frame sequence that utilizes power management bits, in accordance with an embodiment of the invention.

FIG. 4 is a flow chart, which illustrates exemplary steps for using power management bits to reduce power consumption at a wireless station, in accordance with an embodiment of the invention.

FIG. 5 is a flow chart, which illustrates exemplary steps for using power management bits to reduce power consumption at a wireless station, in accordance with an embodiment of the invention.

### DETAILED DESCRIPTION OF THE INVENTION

Certain embodiments of the invention may be found in a method and system for using power management bits in acknowledgment (ACK) frames received from wireless access points (AP). Various embodiments of the invention may provide a reduced turnaround time in comparison to conventional wireless systems that support the U-APSD mode. In various embodiments of the invention, the STA may be operable to exit the PS mode and transmit a trigger frame to the AP. In response to the received trigger frame, the AP may transmit to the STA an ACK frame which comprises an indication, the value of which may indicate to the STA that the AP has no data to transmit to the STA. Upon receipt of the ACK frame, the STA may return to the PS mode based on the indication value.

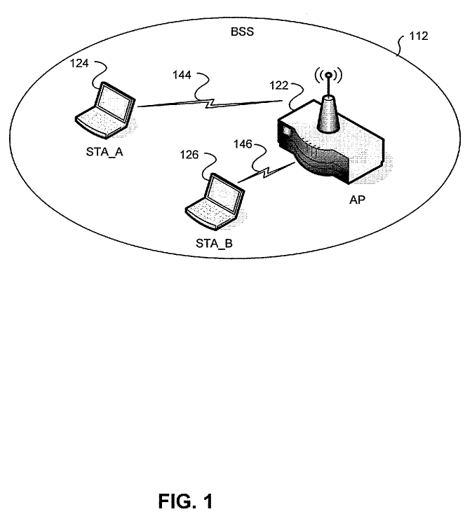

FIG. 1 is a block diagram of an exemplary system for wireless data communication, which may be utilized in connection with an embodiment of the invention. FIG. 1 shows an exemplary BSS 112, which comprises an AP 122, a WLAN station STA_A 124 and a WLAN STA_B 126.

The AP 122 may comprise suitable logic, circuitry, interfaces and/or code that may be operable to transmit and/or receive signals via a wireless communication medium in support of operations as described below.

The WLAN station STA_A 124 and the WLAN STA_B 126 may each comprise suitable logic, circuitry, interfaces and/or code that may be operable to transmit and/or receive signals via a wireless communication medium in support of operations as described below.

In operation within the BSS 112, the AP 122 may communicate with the STA_A 124 via one or more RF channels 144. The AP 122 may communicate with the STA_B 126 via one or more RF channels 146. The STA_A 124 may communicate with the STA_B 126 by sending one or more frames to the AP 122. Upon receipt of the frame(s), the AP 122 may determine that the destination for the frame(s) is the STA_B 126. The AP 122 may then send the frame(s) to the STA_B 126.

When a STA is operating in a power-save (PS) mode, the STA may send one or more frames to the AP. The one or more frame may comprise an indication that informs the AP that the STA is entering a PS mode. When the STA enters the PS mode, one or more circuits within the STA may enter a low-power operating state. Consequently, the AP 122 may have knowledge about the power management mode of the STA_A 124 and/or the STA_B 126.

In an exemplary embodiment of the invention, for example one utilized in connection with an IEEE 802.11 WLAN system, a STA_A 124 may indicate entry into a PS mode by transmitting one or more frames, which are specified based on a medium access control (MAC) frame format. The frame(s) may comprise a frame control field. The frame control field may comprise a power management (PM) field. The PM field may be set to a value, for example PM=1, which indicates that the STA_A 124 is entering a PS mode. The frame, comprising the PM=1 value, may be transmitted by the STA_A 124 to the AP 122. Upon receipt of the frame, the AP 122 may determine that the STA_A 124 is in PS mode.

In various embodiments of the invention, the STA_A 124 may subsequently exit PS mode and transmit a trigger frame to the AP 122. In an exemplary embodiment of the invention, the trigger frame may comprise a QoS-Null frame, a PS-Poll frame and/or a Data frame. Upon receipt of the trigger frame, the AP 122 may determine that there is no data pending transmission to the STA_A 124. After making the determination, the AP 122 may transmit an ACK frame to the STA_A 124. The ACK frame may comprise an indication that the AP 122 has no data pending transmission to the STA_A 124. The time duration that begins when the AP 122 receives the trigger frame and ends when the AP 122 transmits the ACK frame may be referred to as an interframe space (IFS) time interval. In various embodiments of the invention, the IFS time interval may comprise a short IFS (SIFS), point coordination function IFS (PIFS) or extended IFS (EIFS), for example. Upon receipt of the ACK frame from the AP 122, the STA_A 124 may return to the PS mode.

In an exemplary embodiment of the invention, the ACK frame may comprise a PM field. The PM field may comprise a value, which indicates that the AP 122 has no data pending transmission to the STA_A 124. In an exemplary embodiment of the invention, an ACK frame comprising a PM=1 value may indicate that the AP 122 has no data pending transmission to the STA_A 124.

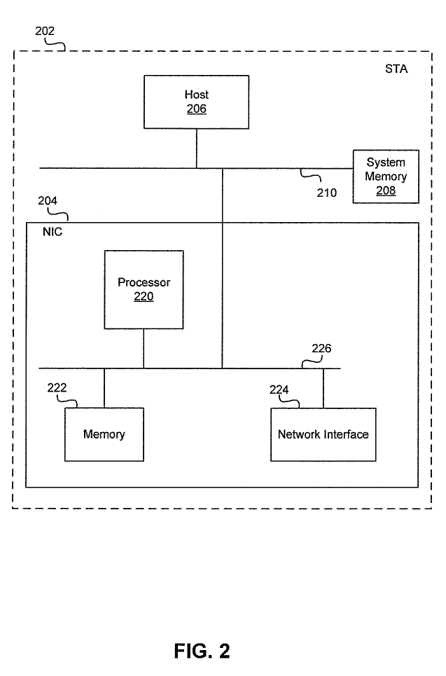

FIG. 2 is a block diagram of an exemplary networked device, which may be utilized in connection with an embodiment of the invention. Referring to FIG. 2, there is shown a STA 202. The STA 202 is an exemplary networked device, which may represent illustrative NIC and host capabilities for STA_A 124, STA_B 126 and/or AP 122 (see FIG. 1). The STA 202 may comprise a network interface controller (NIC) 204, a host 206, a system memory 208, and a system bus 210. The NIC 204 may comprise a processor 220, a memory 222, a network interface 224, and a local bus 226.

The host 206 may comprise suitable logic, circuitry, and/or code that may be operable to receive host sleep and/or wakeup signals and/or generate NIC sleep and/or wakeup signals. The host 206 may be operable to generate frames for transmission by the STA 202 and/or to process frames received by the STA 202. The host 206 may be coupled to the system bus 210.

The system memory 208 may comprise suitable logic, circuitry, and/or code that may be utilized to store, or write, and/or retrieve, or read, information, data, and/or code. The system memory 208 may utilize one or more memory technologies such as random access memory (RAM), and/or nonvolatile memory, for example electrically erasable programmable read only memory (EEPROM). The system memory 208 may be coupled to the system bus 210.

The NIC 204 may comprise suitable circuitry, logic and/or code that may enable the STA 202 to transmit and/or receive frames via a WLAN and/or LAN, for example, an Ethernet network. The NIC 204 may receive NIC sleep and/or wakeup signals and/or generate host sleep and/or wakeup signals. The NIC 204 may be coupled to the system bus 210. The NIC 204 may be coupled to a WLAN and/or LAN network by physical medium, such as cabling, and/or via one or more RF channels.

The processor 220 may comprise suitable logic, circuitry, and/or code that may enable the NIC 204 to sleep and/or wakeup at specified and/or unscheduled times, for example. The processor 220 may enable the NIC 204 to generate, process, transmit and/or receive frames. The processor 220 may enable the NIC 204 to process received NIC sleep and/or wakeup signals and/or generate host sleep and/or wakeup signals. The processor 220 may be coupled to the local bus 226. The local bus 226 may be coupled to the system bus 210.

The memory 222 may comprise suitable logic, circuitry, and/or code that may be utilized to store, or write, and/or retrieve, or read, information, data, and/or executable code. The memory 222 may utilize one or more memory technologies such as random access memory (RAM), and/or nonvolatile memory, for example electrically erasable programmable read only memory (EEPROM). The memory 222 may be coupled to the local bus 226.

The network interface 224 may receive signals, which enable the transmission and/or reception of frames via a LAN or WLAN. The network interface 224 may generate RF signals for transmission of frames via a WLAN and/or generate electrical and/or optical signals for transmission of frames via a LAN. The network interface 224 may detect RF signals for reception of frames via a WLAN and/or detect electrical and/or optical signals for reception of frames via a LAN. The network interface 224 may be coupled to the local bus 226.

In operation for an exemplary embodiment of the invention, the STA 202 may comprise STA_A 124 functionality. The host 206 may receive a sleep signal. The sleep signal may be generated by software executed by the host 206 and/or by the processor 220. The sleep signal may cause the STA 202 to enter a PS mode. In response to receiving the sleep signal, the host 206 may send a NIC sleep signal to the NIC 204. The processor 220 may process the NIC sleep signal and responsively generate a frame. The frame may comprise a PM=1 value to indicate that the STA 202 is entering a PS mode. The processor 220 may retrieve data from the memory 222 to determine the address of the AP to which the frame is to be transmitted. The processor 220 may then send the frame with addressing information to the network interface 224. The network interface 224 may transmit the addressed frame via a network, for example a WLAN.

The network interface 224 may subsequently receive an ACK frame in response to the previously transmitted frame. The network interface 224 may send the received ACK frame to the processor 220. The processor 220 may process the received ACK frame. The processing may comprise operations related to communication protocol processing, for example, updating of connection state information. The updated connection state information may be stored in the memory 222, for example. The processor 220 may send a signal to the host 206 in response to the processing of the ACK frame. The processor 220 may subsequently cause one or more circuits within the NIC 204 to enter a low power operating state. The host 206 may also cause one or more circuits within the STA 202 to enter a low power operating state.

At a subsequent time instant, the host 206 may receive a wakeup signal. The wakeup signal may be generated by software executed by the host 206 and/or by the processor 220. The wakeup signal may cause one or more circuits within the STA 202 to exit the PS mode. In response to receiving the wakeup signal, the host 206 may send a NIC wakeup signal to the NIC 204. The processor 220 may process the NIC wakeup signal and responsively generate a trigger frame. The trigger frame may comprise a QoS-Null frame, a PS-Poll frame and/or a Data frame, for example. The processor 220 may retrieve data from the memory 222 to determine the address of the AP to which the trigger frame is to be transmitted. The processor 220 may then send the trigger frame with addressing information to the network interface 224. The network interface 224 may transmit the addressed trigger frame via a network, for example a WLAN.

The network interface 224 may subsequently receive an ACK frame in response to the previously transmitted frame. The network interface 224 may send the received ACK frame to the processor 220. The processor 220 may process the received ACK frame. The processing may comprise inspecting the value of the PM field within the received ACK frame. In instances when the processor 220 determines that the received ACK frame comprises a PM=1 value, the processor 220 may send a sleep signal to the host 206. The processor 220 may subsequently cause one or more circuits within the NIC 204 to re-enter the low power operating state. The host 206 may also cause one or more circuits within the STA 202 to re-enter the low power operating state.

In operation for an exemplary embodiment of the invention, the STA 202 may comprise AP 122 functionality. The network interface 224 may receive a trigger frame from a STA_A 124 via a network, for example a WLAN. The network interface 224 may send the received trigger frame to the processor 220. The processor 220 may process the received trigger frame. The processing of the received trigger frame may comprise operations related to communication protocol processing, for example, updating of connection state information. The updated connection state information may be stored in the memory 222, for example. During this processing, the processor 220 may process the received trigger frame to identify the STA_A 124, which transmitted the trigger frame.

In an exemplary embodiment of the invention, the host 206 may send data pending delivery to the STA_A 124 to the processor 220, which then buffers the data in memory 222. The processor 220 may determine whether there is any data stored in memory 222, which is pending delivery to the STA_A 124. In instances when there is no data stored in memory 222, which is pending delivery to the STA_A 124, the processor 220 may generate an ACK frame, which is to be transmitted to the STA_A 124. The ACK frame may comprise a PM field value PM=1. The processor may retrieve data from the memory 222 to determine the address of the STA_A 124 to which the ACK frame is to be transmitted. The processor 220 may then send the ACK frame with addressing information to the network interface 224. The network interface 224 may transmit the addressed ACK frame via a network, for example a WLAN. The network interface 224 may transmit the addressed ACK frame within an IFS time duration, for example SIFS, after receipt of the corresponding trigger frame.

In another exemplary embodiment of the invention, the host 206 may buffer data pending delivery to the STA_A 124 in system memory 208. The processor 220 may send the received trigger frame to the host 206. The host 206 may determine whether there is any data stored in the system memory 208, which is pending delivery to STA_A 124. In instances when there is no data stored in system memory 208, which is pending delivery to the STA_A 124, the host 206 may send a signal to the processor 220, which instructs the processor to send an ACK frame that informs the STA_A 124 that there is no buffered data pending delivery. In response, the NIC 204 may send an ACK frame to the STA_A 124 by a procedure which is substantially similar to that described above.

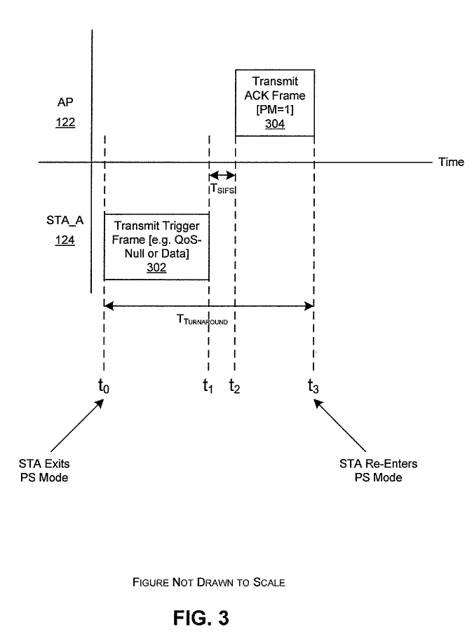

FIG. 3 is a diagram that illustrates an exemplary frame sequence that utilizes power management bits, in accordance with an embodiment of the invention. Referring to FIG. 3, a STA_A 124 may exit PS mode at a time instant labeled t₀. At a time instant labeled t₁, the STA_A 124 may transmit a trigger frame 302 to an AP 122 via a network, for example a WLAN. The trigger frame 302 may comprise a QoS-Null frame, a PS-Poll frame and/or a Data frame. The AP 122 may receive the trigger frame 302 and determine that there is no data pending delivery to the STA_A 124. At a time instant labeled t₂, the AP 122 may transmit an ACK frame 304 to the STA_A 124. The ACK frame 304 may comprise a PM field with a value PM=1. The time duration that begins at time instant t₁ and ends at time instant t₂ may comprise an IFS time duration, T_{IFS}. In an exemplary embodiment of the invention, the IFS time duration may comprise a SIFS time duration, T_{SIFS}, which may be represented as follows:

T_{SIFS}≧t₂−t₁

The ACK frame 304 may subsequently be received at the STA_A 124. In response to receipt of the ACK frame 304, the STA_A 124 may re-enter PS mode at a time instant labeled t₃. The time duration that begins at time instant t₀ and ends at time instant t₃ may be referred to as a turnaround time duration, T_{TURNAROUND}, which may be represented as follows:

T_{TURNAROUND}=t₃−t₀

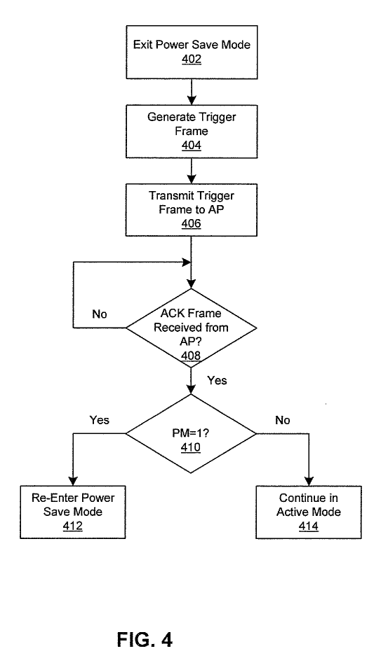

FIG. 4 is a flow chart, which illustrates exemplary steps for using power management bits to reduce power consumption at a wireless station, in accordance with an embodiment of the invention. In an exemplary embodiment of the invention, the steps presented in FIG. 4 may be practiced at a STA. Referring to FIG. 4, in step 402, a STA_A 124 may exit power save (PS) mode. In step 404, the STA_A 124 may generate a trigger frame to poll the AP 122 for any data stored at the AP 122, which is pending delivery to the STA_A 124. In instances when the STA_A 124 has no data to send to the AP 122, the trigger frame may comprise a QoS-Null frame, for example. In instances when the STA_A 124 has data to transmit to the AP 122, the trigger frame may comprise a Data frame, for example. In step 406, the STA_A 124 may transmit the trigger frame to the AP 122. In step 408, the STA_A 124 may wait to receive an ACK frame from the AP 122. In various embodiments of the invention, the STA_A 124 may wait for a limited time duration after which the STA_A 124 may return to step 406 to re-transmit the trigger frame to the AP 122.

When the STA_A 124 receives an ACK frame from the AP 122, in step 410, the STA_A 124 may inspect the power management (PM) field in the received ACK frame to determine whether the PM field comprises a determined value, for example PM=1. In instances when the PM field comprises the determined value, in step 412, the STA_A 124 may re-enter PS mode. In instances when the PM field does not comprise the determined value, in step 414, the STA_A 124 may continue in active mode.

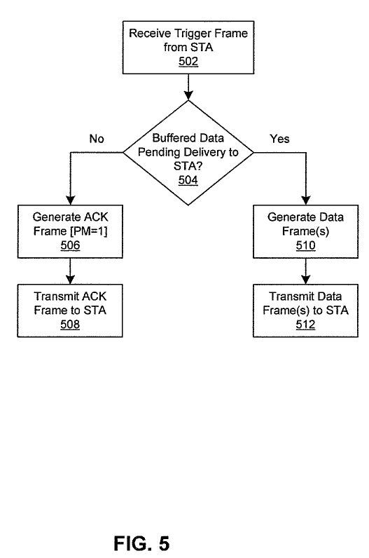

FIG. 5 is a flow chart, which illustrates exemplary steps for using power management bits to reduce power consumption at a wireless station, in accordance with an embodiment of the invention. In an exemplary embodiment of the invention, the steps presented in FIG. 5 may be practiced at an AP. Referring to FIG. 5, in step 502, an AP 122 may receive a trigger frame from a STA_A 124. In step 504, the AP 122 may determine whether there is any buffered data pending delivery to the STA_A 124.

In instances when the AP 122 does not have any buffered data pending delivery to the STA_A 124, in step 506, the AP 122 may generate an ACK frame. The ACK frame may comprise a PM field, wherein the PM field comprises a determined value, for example PM=1. In step 508, the AP 122 may transmit the ACK frame to the STA_A 124. In instances when the AP 122 does have buffer data pending delivery to the STA_A 124, in step 510, the AP 122 may generate one or more Data frames. In step 512, the AP 122 may transmit the Data frames to the STA_A 124.

While exemplary embodiments of the invention have been presented that utilize frames transported via a network, various embodiments of the invention may not be so limited. For example, a frame is an exemplary protocol data unit (PDU). As such, various embodiments of the invention may be practiced in connection with other protocols, such as TCP, IP, RTP and/or UDP. In addition, various embodiments of the invention may be practiced in connection with other PDU types and/or formats, for example packets and/or messages. Furthermore, various embodiments of the invention may not be limited to communication via a network. As such, various embodiments of the invention may be practiced between any two or more communicating entities. In various embodiments of the invention, the two or more communicating entities may each comprise a distinct entity, the communicating entities may comprise subsystems within a common system or the communicating entities may comprise a combination of distinct entities and/or subsystems.

While exemplary embodiments of the invention have been presented in which a WLAN STA operates in active mode or power save mode, various embodiments of the invention may not be so limited. For example, in various embodiments of the invention, a WLAN STA, or other originating communicating entity, may exit a first operating state and enter a second operating state, generate a PDU in the second operating state and transmit the PDU to a destination communicating entity (such as a WLAN AP, for example). The originating communicating entity may subsequently receive an acknowledgment of the transmitted PDU. The originating communicating entity may detect a determined value in the received acknowledgment and determine whether to re-enter the first operating state or continue operating in the second operating state based on the determined value. In various embodiments of the invention that have been presented, an exemplary first operating state may be an power save mode and an exemplary second operating state may be an active mode.

In other exemplary embodiments of the invention, for example, the originating communicating entity may utilize three or more operating states. For example, an exemplary first operating state may be a power save mode and an exemplary second operating state may be a wakeup mode. In the exemplary wakeup mode, the originating communicating entity may power up one or more circuits in a NIC while leaving one or more other circuits within the originating communicating entity in a low power operating state. In such exemplary embodiments, the originating communicating entity may select from a plurality of operating states based on the determined value detected in the acknowledgment. For example, the originating communicating entity may determine whether to re-enter the first operating state or enter a third operating state based on the determined value detected in the acknowledgment. An exemplary third operating state may be an active mode. When transitioning from the exemplary wakeup mode to the exemplary active mode, the originating communicating entity may power up at least a portion of one or more circuits which were not powered up in the wakeup mode, for example. However, in various embodiments of the invention, the originating communicating entity may enter other operating states based on the determined value detected in the acknowledgment.

Another embodiment of the invention may provide a machine and/or computer readable medium, having stored thereon, a computer program having at least one code section executable by a machine and/or computer, thereby causing the machine and/or computer to perform the steps as described herein for using power management bits in acknowledgment frames received from WLAN APs.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for communicating data, the system comprising:
one or more circuits that are operable to transmit a protocol data unit while operating in an active mode;
said one or more circuits are operable to receive an acknowledgment of said transmitted protocol data unit; and
said one or more circuits are operable to determine whether to enter a power save mode based on power management information in said received acknowledgment.

2. The system according to claim 1, wherein said one or more circuits are operable to detect a determined value in said power management information.

3. The system according to claim 2, wherein said one or more circuits are operable to enter said power save mode based on said determined value.

4. The system according to claim 2, wherein said one or more circuits are operable to continue operation in said active mode based on said determined value.

5. The system according to claim 2, wherein said one or more circuits are operable to enter one or more subsequent operating states based on said determined value.

6. The system according to claim 1, wherein said one or more circuits are operable to transmit said protocol data unit via a network.

7. The system according to claim 6, wherein said one or more circuits are operable to receive said acknowledgment via said network.

8. The system according to claim 1, wherein said protocol data unit is a trigger frame.

9. The system according to claim 8, wherein said trigger frame is at least one or more of a QoS-Null frame, a PS-Poll frame and a Data frame.

10. The system according to claim 8, wherein said trigger frame comprises a request that a recipient of said trigger frame determine whether there is data pending delivery to a communication device identified in said trigger frame.

11. A method for communicating data, the system comprising:
transmitting a protocol data unit while operating in an active mode;
receiving an acknowledgment of said transmitted protocol data unit; and
determining whether to enter a power save mode based on power management information in said received acknowledgment.

12. The method according to claim 11, comprising detecting a determined value in said power management information.

13. The method according to claim 12, comprising entering said power save mode based on said determined value.

14. The method according to claim 12, comprising continuing operation in said active mode based on said determined value.

15. The method according to claim 12, comprising entering one or more subsequent operating states based on said determined value.

16. The method according to claim 11, comprising transmitting said protocol data unit via a network.

17. The method according to claim 16, comprising receiving said acknowledgment via said network.

18. The method according to claim 11, wherein said protocol data unit is a trigger frame.

19. The method according to claim 18, wherein said trigger frame is at least one or more of a QoS-Null frame, a PS-Poll frame and a Data frame.

20. The method according to claim 18, wherein said trigger frame comprises a request that a recipient of said trigger frame determine whether there is data pending delivery to a communication device identified in said trigger frame.
